(19) United States
(12) Patent Application Publication
(10) Pub. No.: US 2025/0033166 A1
(43) Pub. Date: Jan. 30, 2025

(54) BLANKET CLAMP TOOL AND METHOD OF USE

(71) Applicant: Adam J Kriz, Grain Valley, MO (US)

(72) Inventor: Adam J Kriz, Grain Valley, MO (US)

(21) Appl. No.: 18/911,701

(22) Filed: Oct. 10, 2024

Related U.S. Application Data
(63) Continuation-in-part of application No. 18/121,161, filed on Mar. 14, 2023.
(60) Provisional application No. 63/543,363, filed on Oct. 10, 2023.
(60) Provisional application No. 63/319,649, filed on Mar. 14, 2022.

(51) Int. Cl. B25B 5/04; H02G 1/02

(52) U.S. Cl. CPC B25B 5/04; H02G 1/02

(57) ABSTRACT

A blanket clamp which includes first and second lever arm each with a handle and an upper curved jaw. The first and second lever arms cross over each other and are secured together at a center pivot point, with a torsion spring positioned at the pivot point and configured to bias the upper jaws of the clamp in a closed position. A trigger element connected to the first lever arm is configured to lock the clamp in a desired closed, open, or partially closed position includes a toothed end which engages ratchet teeth located on the second lever arm.

### CROSS-REFERENCE TO RELATED APPLICATION

This application claims priority in U.S. Provisional Patent Application No. 63/543,363, filed Oct. 10, 2023, and is also a continuation-in-part of and claims priority in U.S. patent application Ser. No. 18/121,161, filed Mar. 14, 2023, which claims priority in U.S. Provisional Patent Application No. 63/319,649, filed Mar. 14, 2022, all of which are incorporated herein by reference.

### BACKGROUND OF THE INVENTION

### 1. Field of the Invention

The present invention relates generally to clamps and methods for use thereof, and more specifically to a blanket clamp system for securing an electrically insulating blanket to an electrical distribution line.

### 2. Description of the Related Art

Electrical linemen rely on various forms of personal protective equipment to allow them to safely work with, and in proximity to, high voltage electrical lines. For example, linemen regularly use insulating gloves and sleeves, hard hats, face shields, insulated tools, as well as measuring equipment such as voltmeters and voltage detectors to ensure their safety while working in high voltage environments.

In addition, electrically insulating blankets are commonly used to cover nearby electrical lines to prevent inadvertent contact by the lineman with those lines, or to prevent inadvertent contact of tools or other equipment with the electrical line. Insulating blankets are typically made of rubber and are available in various insulating grades for use with various voltages, with thinner rubber blankets typically rated for use only with lower voltages and thicker rubber blankets rated for use with higher voltages.

In use, the insulating blanket is draped over an electrical line and secured in place using one or more blanket clamps to provide an insulating barrier surrounding the power line. Typical blanket clamps are made from an electrically insulating material, such as plastic, and use a torsion spring to secure the side-by-side jaws of the plier-like clamp around the blanket and underlying power line to keep the blanket in place. With a plurality of blanket clamps placed along the draped blanket, the blanket is generally secured to the power line to provide protection to the lineman.

While useful, known blanket clamp designs are not without drawbacks. For example, securement of the clamp to the line relies entirely on the bias or strength of the torsion spring to secure the jaws of the clamp in a closed position. For example, while a clamp having a torsion spring of low bias would allow the lineman to easily open the jaws to place it around the blanket and line, such a clamp would provide minimal holding ability. Likewise, a clamp having a torsion spring of high bias would provide better securement of the blanket to the power line but may be unwieldly for the lineman to operate. Thus, the strength of the torsion spring in a typical blanket clamp requires a compromise between how tightly the clamp will secure the blanket to the power line and the ease of operation for the lineman in placing the clamp.

Furthermore, because typical blanket clamps rely on the bias or strength of the torsion spring to secure the blanket, it is common for movement of the blanket to overcome the bias of the torsion spring, allowing the blanket to move, or in some cases, pull free from the blanket clamp. For instance, a wind gust against an extended blanket can provide a significant force against the spring bias of the blanket clamp, a common occurrence when working on overhead lines outdoors.

Thus, it can be seen that there is a need in the art for a blanket clamp that provides ease of use and improved securement of insulating electrical blankets to power lines. Heretofore there has not been available a system or method for an electrical blanket clamp with the advantages and features of the present invention.

Heretofore there has not been available a system or method for a blanket clamp with the advantages and features of the present invention.

### BRIEF SUMMARY OF THE INVENTION

The present invention is directed to a blanket clamp with ratchet mechanism for securing a protective electrically insulating blanket to an electrical line, such as a power distribution line.

In an exemplary embodiment, the blanket clamp includes first and second lever arms, each extending from a generally straight lower protruding handle to an upper curved jaw. The first and second lever arms cross over each other and are secured together at a center pivot point, with a torsion spring positioned at the pivot point and configured to bias the upper jaws of the clamp in an open position.

A ratchet mechanism configured to lock the clamp in a desired opened, closed, or partially closed position comprises a fixed toothed section attached to or formed on the first lever arm and a rotating, actuated engagement lever pivotably attached to the second lever arm. The actuated engagement lever on the second lever arm comprises an elongate portion extending outwardly for actuation by a user's thumb and/or fingers and a protruding cam portion for engagement with the fixed tooth section on the first lever arm. A lever spring attached to the second lever arm is positioned against the elongated portion of the actuated engagement lever so that in the normal, non-actuated position, the cam portion is engaged against the fixed toothed section. The actuated engagement lever could have additional grips for additional fingers as well.

The engagement between the actuated engagement lever and the fixed tooth portion thus provides a ratchet mechanism to temporarily lock the first and second lever arms in position with respect to each other. A user may thus open the blanket clamp by squeezing the two lower protruding handles of the first and second lever arms together so that the jaws of the first and second lever arms move apart (i.e., to a opened position), with the cam of the actuated engagement lever ratcheting along the fixed tooth section, locking the lever arms in position with respect to each other at each step of the ratchet. To release the jaws, a user actuates the elongated portion of the actuated engagement lever to pull the cam from the fixed tooth portion and allow the torsion spring bias between the two lever arms to return the jaws to their original position.

The ratchet mechanism thus provides a mechanical stop or lock that prevents the jaws from moving apart from each other or together until a user affirmatively actuates the actuated engagement lever. Unlike conventional blanket clamps where movement of the insulating blanket may overcome the spring bias of the clamp, a wind gust or movement of the insulating blanket will not overcome the positive lock of the ratchet mechanism of the blanket clamp of the present invention.

### BRIEF DESCRIPTION OF THE DRAWINGS

The drawings constitute a part of this specification and include exemplary embodiments of the present invention illustrating various objects and features thereof.

FIG. 1 is a three-dimensional exploded isometric view of a preferred embodiment of the present invention.

FIG. 2 is a side elevational view of the embodiment thereof assembled.

FIG. 3 is a left side elevational view of a first half of the embodiment thereof.

FIG. 4 is a right side elevational view thereof.

FIG. 5 is a front elevational view thereof.

FIG. 6 is a rear elevational view thereof.

FIG. 7 is a top plan view thereof.

FIG. 8 is a button plan view thereof.

FIG. 9 is a left side elevational view of a second half of the embodiment thereof.

FIG. 10 is a right side elevational view thereof.

FIG. 11 is a front elevational view thereof.

FIG. 12 is a rear elevational view thereof.

FIG. 13 is a top plan view thereof.

FIG. 14 is a button plan view thereof.

FIG. 15 is a left side elevational view of a lever element of the embodiment thereof.

FIG. 16 is a front elevational view thereof.

FIG. 17 is a right side elevational view thereof.

FIG. 18 is a rear elevational view thereof.

FIG. 19 is a top plan view thereof.

FIG. 20 is a bottom plan view thereof.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Embodiment Blanket Clamp 2

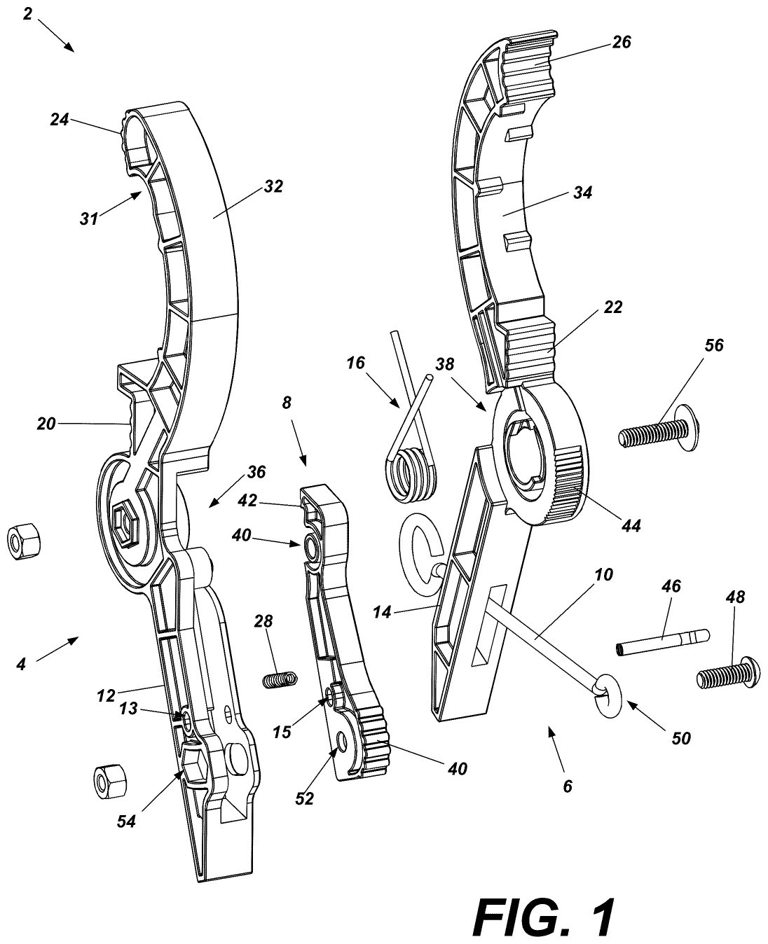

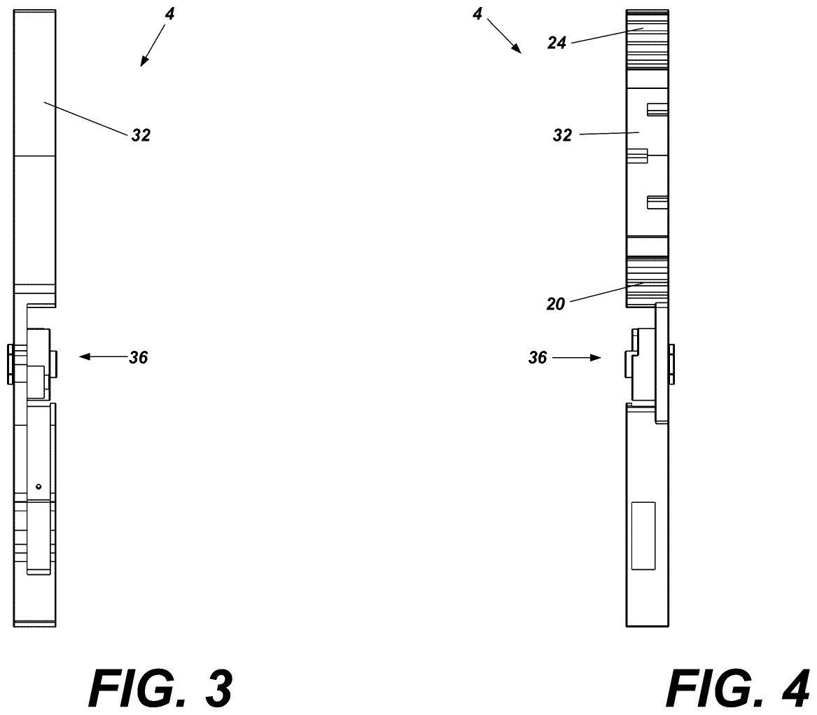

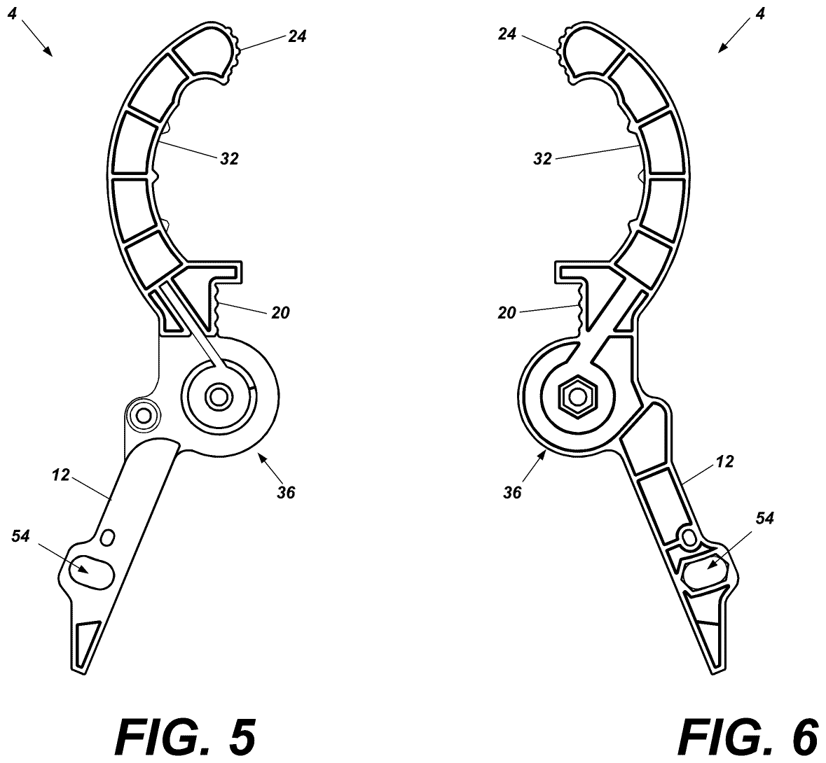

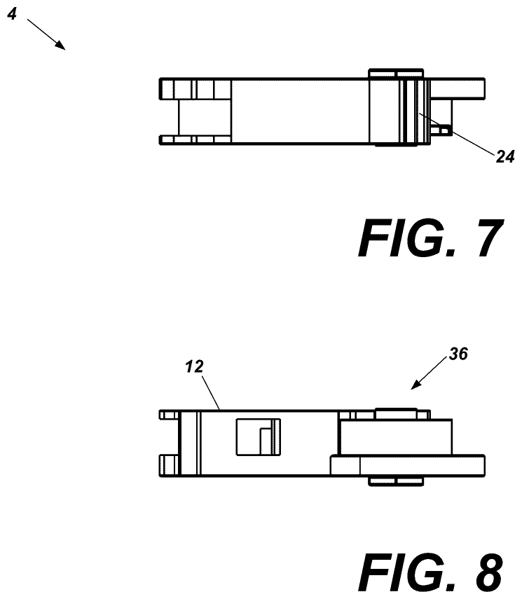

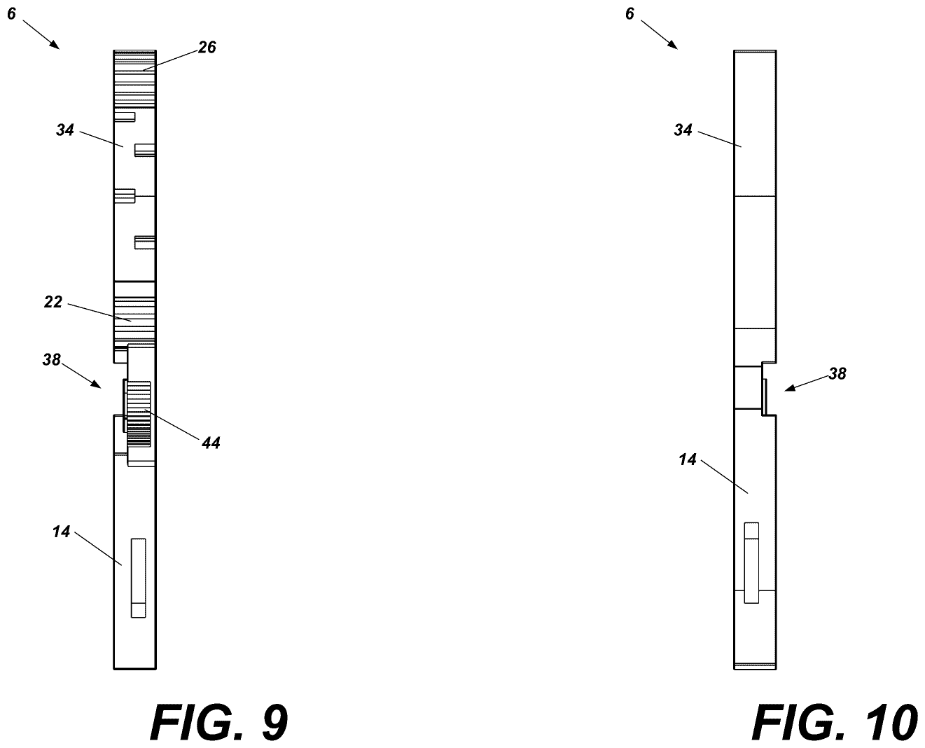

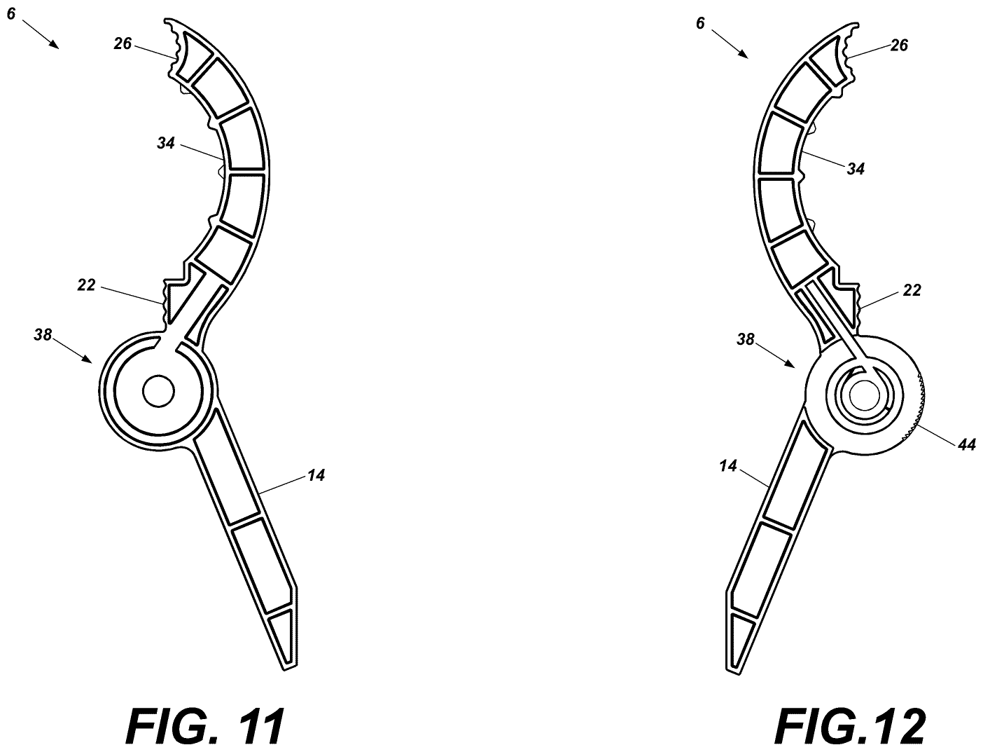

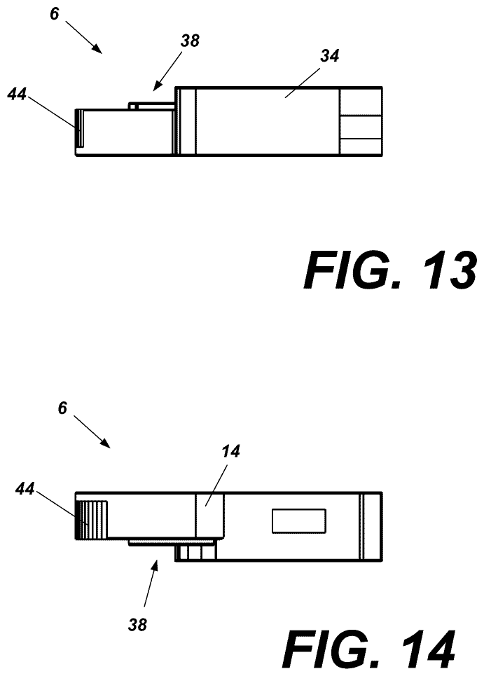

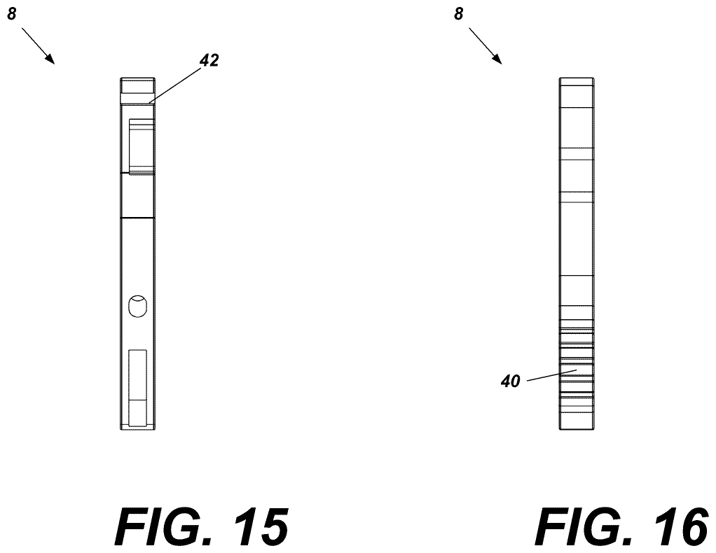

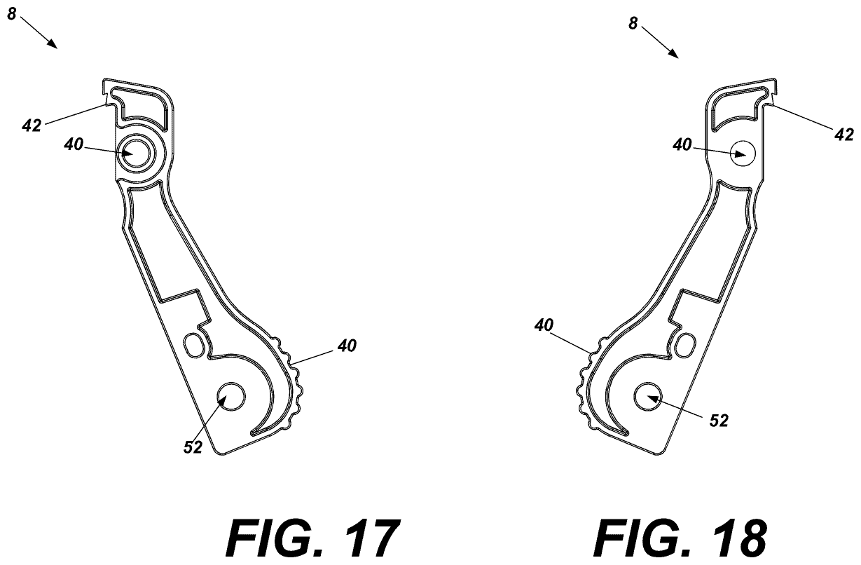

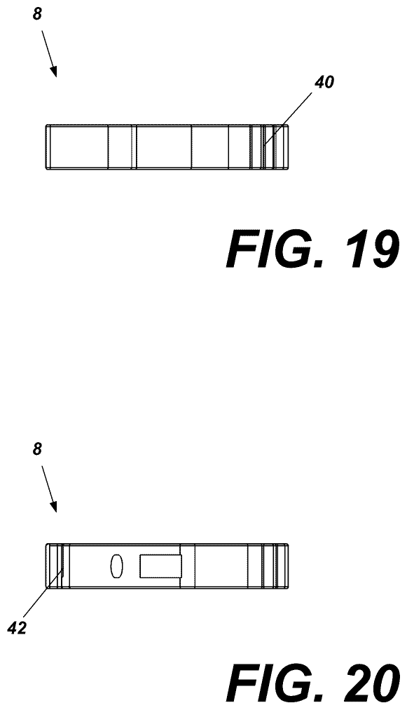

As shown in FIGS. 1-20, the present invention provides a blanket clamp 2 formed from a first lever arm 4 and a second lever arm 6 joined about a trigger element 8. A bolt 56 and torsion spring 16 join the elements together along a pivot point axle defined by the bolt. The first lever arm 4 has a first connector 36 which connects to a second connector 38 of the second lever arm via the bolt. The trigger element 8 is similarly connected to the first lever arm and the second lever arm via a pin 46 about which the trigger element actuates.

The first lever arm 4 has an elongated curvilinear arm forming a lower handle 12 and an upper jaw 32. The tip of the upper jaw forms an insert 24 with a number of arcuate members intended to be received by a receiver 26 of the second upper jaw 34. The interior surface of the upper jaw 32 is intended to grip a blanket housed over an electrical conductor or some other suitable generally circular element.

The second lever arm similarly has an elongated curvilinear arm forming a lower handle 14 and an upper jaw 34. The tip of the upper jaw forms a receiver 26 with a number of arcuate members. In the same manner, the interior surface of the upper jaw is intended to grip a blanket housed over an electrical conductor or some other suitable generally circular element. Together, the two jaws form a space 30 to receive and secure about the generally circular element.

Squeezing the first and second lever arms at the handles 12, 14 will transition the clamp from a closed orientation to an open orientation, rotating the upper jaws 32, 34 about the bolt 56. The trigger element 8 allows the user to selectively lock and close the clamp about a blanket wrapped about a power line, thereby clamping it in place.

The first lever arm 4 and trigger element 8 include corresponding cotter pin receivers 13, 15 which can receive a standard cotter pin configured to disengage the locking mechanism if needed.

A shotgun loop is connected to the clamp which can be used to grab and gather cables or wires. These may be adjustable about the handle portions of the lever arms and also connects to the trigger element 8 via receiver hole 52 and the first lever arm 4 handle 12 via an elongated receiver hole 54 via a bolt 48 passing through an end 50 of the shotgun loop 10.

The second lever arm 6 includes a number of ratchet teeth 44 which can engage a tooth 42 of the trigger element 8. Pressing against an actuated end 40 of the trigger element 8 pivots the trigger element about the mounting pin 46, which releases the tooth 42 from the ratchet teeth 44, which allows the clamp to be opened or closed. A trigger spring 28 helps to bias the trigger element against the ratchet teeth 44. The actuated end 40 of the trigger element could also be formed into a grip which can be actuated using one or more fingers or merely a thumb. The elongated receiver hole 54 of the first lever arm 4 allows the trigger to freely move the end of the shotgun loop 10 up and down as it is activated.

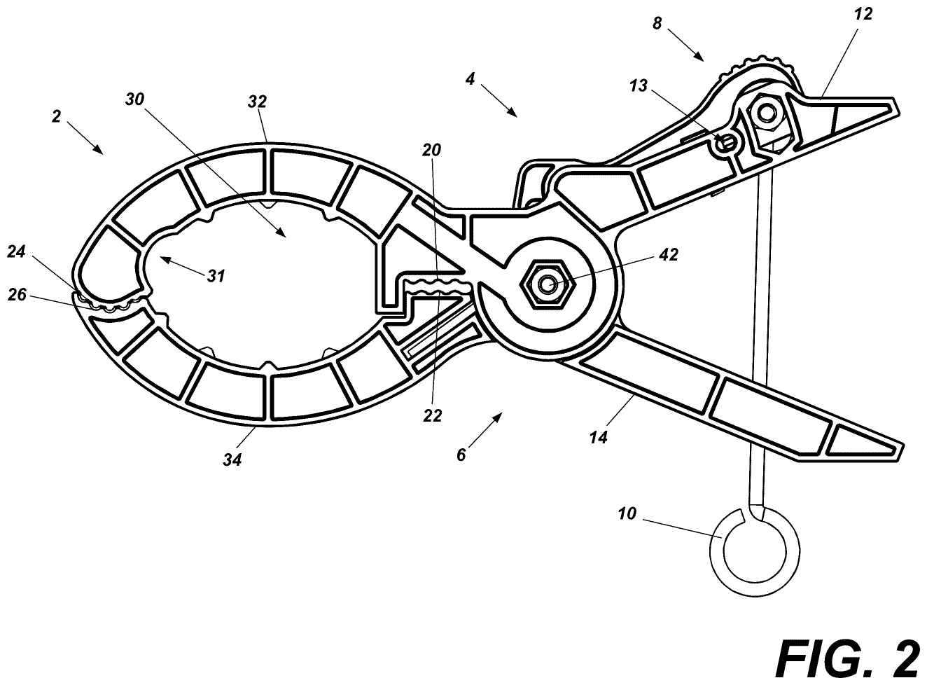

The first lever arm 4 and second lever arm 6 have a first wire grip portion 20 and a second wire grip portion 22, respectively. As shown in FIG. 2, these wire grip portions 20, 22 interlock to allow the clamp 2 to clamp down onto wires of varying diameters. Typical clamps in the industry have pre-defined wire holes sized to specific wire types, but space is limited between the jaws of the clamp, and therefore it is ideal to have a wide away of wire grip options, which the wire grip portions 20, 22 of the present invention provide. As shown in FIG. 2, there is space between the wire grip portions 20, 22 when the clamp is in its closed orientation, the space being designed to fit the minimum necessary wire diameter.

One of the jaws 32, 34 may contain a rounded recess 31 to hold wire or mechanical jumper wire. When used, the wire(s) fall into these recesses, thereby placing tension from those wires onto only one side of the clamp into the respective jaw possessing the recess 31, thereby preventing the tension from prematurely opening the clamp.

The jaws of the lever arms could be covered with over-molded elements for further utility and protection.

It is to be understood that while certain embodiments and/or aspects of the invention have been shown and described, the invention is not limited thereto and encompasses various other embodiments and aspects.

1. A clamp system comprising:
a first lever arm comprising an elongated curvilinear arm forming a first lower handle and a first upper jaw, said first lever arm further comprising a toothed portion;
a second lever arm comprising an elongated curvilinear arm forming a second lower handle and a second upper jaw;
a torsion spring comprising a first leg positioned against an inner surface of said first lever arm and a second leg positioned against an inner surface of said second lever arm such that said torsion spring provides a bias force against each of said first and second lever arms, thereby forcing the first upper jaw and the second upper jaw closed;
said first lever arm, said second lever arm, and said torsion spring configured to be transformed between a first, closed orientation based upon the bias force of said torsion spring and a second, opened orientation whereby both of said first and second lower handles of said first and second lever arms are depressed towards one another;
a bolt connecting said first lever arm, said second lever arm, and said torsion spring about said clamp pivot axis;
said second lever arm comprising a number of ratchet teeth in a circumference about said clamp pivot axis;
a trigger element connected to said first lever arm, said trigger element comprising a trigger spring, an actuated end, a toothed end, and a trigger pin securing said trigger element between said first lever arm and said second lever arm about a trigger pivot axis;
said trigger spring biased to push said toothed end toward said ratchet teeth of said second lever arm, whereby said toothed end and said ratchet teeth lock said first lever arm and said second lever arm in place about said clamp pivot axis; and
whereby depressing said trigger element releases said toothed end, unlocking said first lever arm and said second lever arm about said pivot axis.

2. The clamp system of claim 1, further comprising:
said first lever arm comprising a first set of interlocking wire grips;
said second lever arm comprising a second set of interlocking wire grips; and
said first set of interlocking wire grips configured to oppose said second set of interlocking wire grips when said first lever arm and said second lever arm are in said second, closed orientation such that said first and second sets of interlocking wire grips are configured to grip onto wires having varying diameters.

3. The clamp system of claim 1, wherein said clamp is configured to grip a blanket about an electrical wire.

4. The clamp system of claim 1, further comprising:
a shotgun loop connected to said first lower handle of said first lever arm and said trigger element; and
said shotgun loop configured to receive electrical components.

5. The clamp system of claim 1, further comprising one of said first and second upper jaws comprising at least one rounded recess configured for receiving at least one wire when said clamp is engaged.

6. The clamp system of claim 1, further comprising a cotter pin configured to selectively engage said first lever arm and said trigger element via a pair of cotter pin receivers.

7. A method of securing a blanket about an electrical wire, the method comprising the steps:
providing a clamp comprising a first lever arm and a second lever arm connected about a clamp pivot axis;
wherein said first lever arm comprising an elongated curvilinear arm forming a first lower handle and a first upper jaw;
wherein said second lever arm comprising an elongated curvilinear arm forming a second lower handle, a second upper jaw, and a number of ratchet teeth in a circumference about said clamp pivot axis;
providing a torsion spring comprising a first leg positioned against an inner surface of said first lever arm and a second leg positioned against an inner surface of said second lever arm such that said torsion spring provides a bias force against each of said first and second lever arms, thereby forcing the first upper jaw and the second upper jaw together;
said first lever arm, said second lever arm, and said torsion spring configured to be transformed between a first, closed orientation based upon the bias force of said torsion spring and a second, open orientation whereby both of said first and second lower handles of said first and second lever arms are depressed towards one another;
providing a trigger element connected to said first lever arm about a trigger pivot pin;
connecting said first lever arm, said second lever arm, and said torsion spring about said pivot axis with a bolt;
wherein said trigger element comprising a toothed end, and a trigger spring;
wherein said trigger spring is biased to push said trigger element away from said first lever arm and thereby pushing said toothed end of said trigger element toward said ratchet teeth of said second lever arm, whereby said toothed end and said ratchet teeth locking said first lever arm and said second lever arm in place about said clamp pivot axis;
depressing said trigger element, rotating it about said trigger pivot pin, thereby releasing said toothed end from said ratchet teeth and unlocking said first lever arm and said second lever arm about said clamp pivot axis;
squeezing said first and second lower handles of said first and second lever arms, thereby opening said first and second upper jaws relative to said clamp pivot axis; and
releasing said trigger element, thereby biasing said toothed end toward said ratchet teeth, thereby locking said first lever arm and said second lever arm.
